(19) United States
(12) Patent Application Publication
(10) Pub. No.: US 2006/0145646 A1
(43) Pub. Date: Jul. 6, 2006

(54) Method and apparatus to automatically tune paper-feeding controller

(76) Inventor: Sung-ryul Lee, Seoul (KR)

Correspondence Address: STANZIONE & KIM, LLP, 919 18TH STREET, N.W., SUITE 440, WASHINGTON, DC, 20006, US

(21) Appl. No.: 11/320,793

(22) Filed: Dec. 30, 2005

(30) Foreign Application Priority Data
Dec. 30, 2004 (KR) 2004-116959

(51) Int. Cl. H02K 1/00

(52) U.S. Cl. 318/538

(57) ABSTRACT

A method and apparatus to automatically tune a paper-feeding controller included in a paper-feeding system of a printer by eliminating effects of disturbance and thus accurately and automatically calculating gain of the paper-feeding controller. The method of automatically tuning a controller in a paper-feeding system of a printer using a DC motor includes acquiring input and output data of the paper-feeding system by conducting an open loop test, pre-filtering the input and output data to eliminate a drift offset from the acquired input and output data, identifying a system using the pre-filtered input and output data and inducing a system model and calculating a gain of the controller using the induced system model and controlling a velocity of the paper-feeding system according to the calculated gain. Accordingly, the method can minimize effects of disturbances present in the paper-feeding system of the printer, acquire a more accurate system model, and ultimately, obtain improved control performance.

### CROSS-REFERENCE TO RELATED APPLICATIONS

This application claims the priority under 35 U.S.C. § 119 of Korean Patent Application No. 2004-116959, filed on Dec. 30, 2004, in the Korean Intellectual Property Office, the disclosure of which is incorporated herein in its entirety by reference.

### BACKGROUND OF THE INVENTION

1. Field of the Invention

The present general inventive concept relates to a paper-feeding system of a printer, and more particularly, to a method and apparatus to automatically tune a paper-feeding controller included in a paper-feeding system of a printer by eliminating effects of disturbances and thus accurately and automatically calculating a gain of the paper-feeding controller.

2. Description of the Related Art

PID (proportional, integral, and derivative) controllers are widely used in paper-feeding systems of printers using DC motors as a driving source. A PID controller includes a proportional controller, an integral controller, and a derivative controller. Also, Pi controllers including proportional controllers and integral controllers are widely used.

A conventional method of controlling a PI or PID action used in various process instrument control systems and an apparatus thereof are disclosed in U.S. Pat. No. 5,535,117.

Generally, a paper-feeding system of a printer needs to automatically tune a gain of a paper-feeding controller. FIG. 1 is a block diagram illustrating a conventional system identification process model. Referring to FIG. 1, a test signal generator 100 generates a test signal and transmits the test signal to a process plant 110, a process model 120, and an adjustment mechanism 130. The process plant 110 is a control target, and may be, for example, an inkjet printer system or a linefeed system. The process model 120 is for identifying a paper-feeding system. As illustrated in FIG. 1, the process model 120 can be approximated to the process plant 110 by minimizing errors of the process model 120.

To automatically tune the gain of the paper-feeding controller included in the paper-feeding system of a printer, a test signal is transmitted to the paper-feeding system, and input and output data of the paper-feeding system is obtained. Then, based on the obtained input and output data, a system model is estimated using, for example, a least square method. The gain of the paper-feeding controller can be automatically tuned using the estimated model. 07

As described above, the least square method has been used to approximate the paper-feeding system, and ultimately, estimate the system model. As illustrated in FIG. 1, the test signal is transmitted to the paper-feeding system (i.e., the process plant 110), and an output signal y of the paper-feeding system is measured. Then, system parameters θ are estimated using the least square method in the adjustment mechanism 130, and a system model y_{—estimated} is estimated based on the estimated system parameters θ.

A printer servo system has various types of disturbances, such as load friction, torque ripples, ripples caused by machine vibrations, and drift offsets. FIGS. 2 through 4 illustrate the various types of disturbances. FIG. 2 is a graph illustrating an output signal distorted due to load friction. FIG. 3 is a graph illustrating ripples of an output signal caused by motor cogging and machine vibrations. FIG. 4 is a graph illustrating an output signal showing a drift phenomenon.

When the conventional least square method is used, it is difficult to approximate the process model 120 to the process plant 110 due to the disturbances described above. Therefore, it is desirable to obtain estimation results not affected by the disturbances.

### SUMMARY OF THE INVENTION

The present general inventive concept provides a method of automatically tuning a paper-feeding controller included in a paper-feeding system of a printer by eliminating effects of disturbances using a pre-filter, and thus, automatically calculating a gain of the paper-feeding controller.

The present general inventive concept also provides an apparatus to automatically tune a paper-feeding controller included in a paper-feeding system of a printer by eliminating effects of disturbances using a pre-filter and thus automatically calculating a gain of the paper-feeding controller.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a method of automatically tuning a controller in a paper-feeding system of a printer using a DC motor. The method includes acquiring input and output data of the paper-feeding system by conducting an open loop test, eliminating a drift offset from the acquired input and output data, identifying a system using the pre-filtered input and output data and inducing a system model, and calculating a gain of the controller using the induced system model and controlling a velocity of the paper-feeding system according to the calculated gain.

The foregoing and/or other aspects of the present general inventive concept may also be achieved by providing an apparatus to automatically tune a controller in a paper-feeding system of a printer using a DC motor. The apparatus includes a data acquirer to acquire input and output data of the paper-feeding system by conducting an open loop test, a pre-filter to eliminate a drift offset from the acquired input and output data, a system model inducer to identify a system using the pre-filtered input and output data and to induce a system model, and a gain calculator to calculate a gain of the controller using the induced system model and to control a velocity of the paper-feeding system.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating a conventional system identification process model;

FIG. 2 is a graph illustrating a conventional output signal distorted due to load friction;

FIG. 3 is a graph illustrating ripples of a conventional output signal caused by motor cogging and machine vibrations;

FIG. 4 is a graph illustrating a conventional output signal showing a drift phenomenon;

FIG. 5 is a flowchart illustrating a method of automatically tuning a paper-feeding controller according to an embodiment of the present general inventive concept;

FIG. 6 is a block diagram illustrating an apparatus to automatically tune a paper-feeding controller according to an embodiment of the present general inventive concept;

FIG. 7 is a flowchart illustrating a method of automatically tuning a paper-feeding controller according to another embodiment of the present general inventive concept;

FIG. 8 is a graph illustrating a test input signal and the test input signal filtered by a low pass filter;

FIG. 9 is a graph illustrating a velocity output signal and the velocity output signal filtered by the low pass filter;

FIG. 10 is a graph illustrating a test input signal filtered by the low pass filter and a drift offset;

FIG. 11 is a graph illustrating a velocity output signal filtered by the low pass filter and a drift offset;

FIG. 12 is a graph illustrating a final output of a pre-filter that filtered the test input signal;

FIG. 13 is a graph illustrating a final output of the pre-filter that filtered the velocity output signal;

FIG. 14 is a graph illustrating an output signal controlled by the paper-feeding controller based on gain of the paper-feeding controller calculated using the method according to the present invention; and

FIG. 15 is a chart illustrating a value of a model parameter and that of a parameter of the paper-feeding controller calculated using the method according to the present invention.

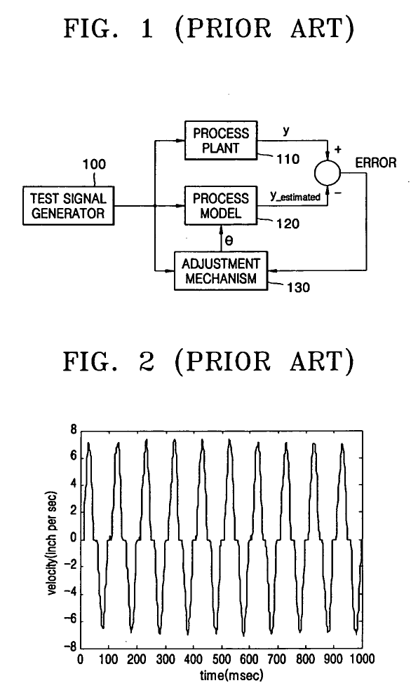

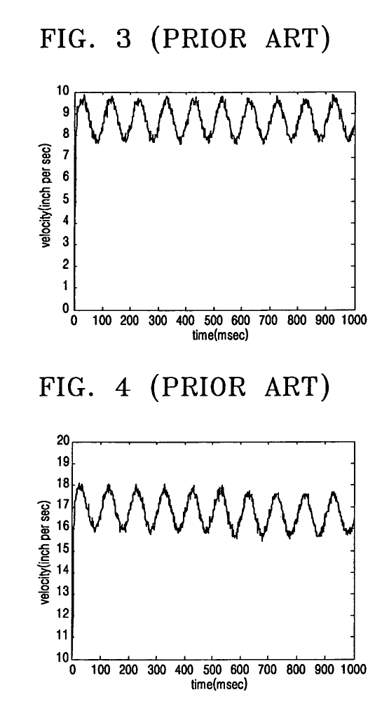

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

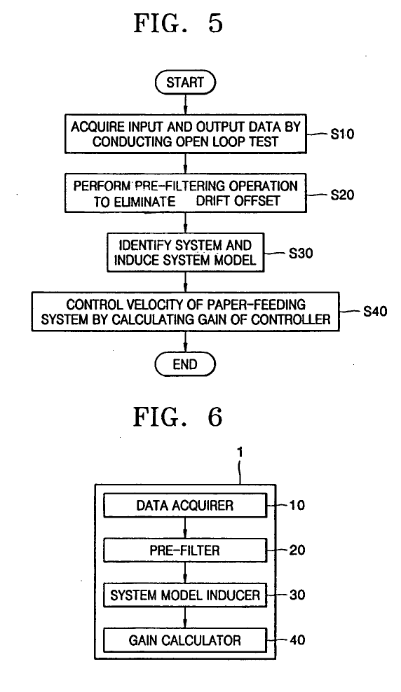

FIG. 5 is a flowchart illustrating a method of automatically tuning a paper-feeding controller according to an embodiment of the present general inventive concept. Referring to FIG. 5, to automatically tune the paper-feeding controller included in a paper-feeding system of a printer using a DC motor, an open loop test is conducted to obtain input and output data of the paper-feeding system of the printer (S10). The obtained input and output data is pre-filtered to eliminate a drift offset from the obtained input and output data (S20). Using the pre-filtered input and output data, the paper-feeding system is approximated and a system model to model the paper-feeding system is induced (S30). A gain of the paper-feeding controller is calculated using the induced system model, and a velocity of the paper-feeding system is controlled by the paper-feeding controller based on the calculated gain (S40).

At operation S10, the open loop test may include inputting a test signal to the paper-feeding system that maintains a plus or minus sign of the output velocity of the paper-feeding system unchanged and eliminates effects of load friction on the output velocity. At Operation S20, the obtained input and output data may be pre-filtered to eliminate a drift offset using a predetermined curve fitting method to design a filter, and may be pre-filtered to eliminate torque ripples and ripples caused by machine vibrations using a low pass filter.

At operation S30, the system model can be induced from the pre-filtered input and output data using a least square method. At operation S40, the gain of the paper-feeding controller can be calculated by a pole placement method using the induced system model.

The paper-feeding controller may be a PID (proportional, integral, and derivative) or a PI controller. The PID controller includes a proportional controller, an integral controller, and a derivative controller. The PI controller includes a proportional controller and an integral controller.

FIG. 6 is a block diagram illustrating an apparatus 1 to automatically tune a paper-feeding controller according to an embodiment the present general inventive concept. The apparatus 1 to automatically tune the paper-feeding controller, included in a paper-feeding system of a printer and using a DC motor, includes a data acquirer 1 0, a pre-filter 20, a system model inducer 30, and a gain calculator 40.

The data acquirer 10 conducts an open loop test and acquires input and output data of the paper-feeding system. The data acquirer 10 may acquire the input and output data of the paper-feeding system by designing a test signal, which can maintain a plus or minus sign of an output velocity of the paper-feeding system unchanged, and input the test signal to the paper-feeding system to eliminate the effects of load friction.

The pre-filter 20 can eliminate a drift offset from the input and output data acquired by the data acquirer 10. For example, the pre-filter 20 can eliminate the drift offset using a predetermined curve fitting method to design a drift filter. The pre-filter 20 also can include a low pass filter to filter torque ripples and ripples caused by machine vibrations.

The system model inducer 30 can induce a system model to approximate the paper-feeding system using the input and output data filtered by the pre-filter 20. For example, the system model inducer 30 can induce the system model from the pre-filtered input and output data using a least square method.

The gain calculator 40 calculates a gain of the paper-feeding controller using the system model induced by the system model inducer 30 to control the velocity of the paper-feeding system. For example, the gain calculator 40 can calculate the gain of the paper-feeding controller by a pole placement method using the induced system model. The paper-feeding controller may be a PID controller or a PI controller.

The output velocity of a paper-feeding servo system of a printer using a DC motor can be approximated to a linear system through Laplace transformation as follows.

$$Y ( s ) = \frac{K}{Ts + 1} U ( s ) + d ( s ) , \qquad Equation 1 ]$$

where Y(s) denotes velocity, U(s) denotes system input, d(s) denotes disturbance, K denotes system DC gain, and T denotes a time constant.

The disturbance d(s) of the servo system of the printer can be modelled into load friction, torque ripples, ripples caused by machine vibrations, and a drift offset through experimental observation. When a conventional least square method is used, it is difficult to approximate a process model to a process plant due to such disturbances. Therefore, as described above, in the embodiments of the present general inventive concept, a signal is pre-filtered to eliminate the disturbances before using the least square method to obtain estimation results.

Accordingly, the embodiments of the present general inventive concept can accurately estimate parameters (K, T) despite the disturbance d(s) present in an actual system as shown in Equation 1. In other words, the pre-filter 20 to filter the disturbance d(s) allows the system model inducer 30 to estimate the parameters (K, T) without being affected by the disturbance d(s).

The effects of the load friction can be eliminated by the data acquirer 10 designing the test signal such that the plus or minus sign of the output velocity of the paper-feeding system is maintained unchanged. The torque ripples and the ripples caused by the machine vibrations can be eliminated using the low pass filter included in the pre-filter 20. The low pass filter may be implemented as a general finite impulse response (FIR) digital filter. A cut-off frequency of the low pass filter can be designed to be greater than a frequency of the test signal and smaller than frequencies of output ripples and noise.

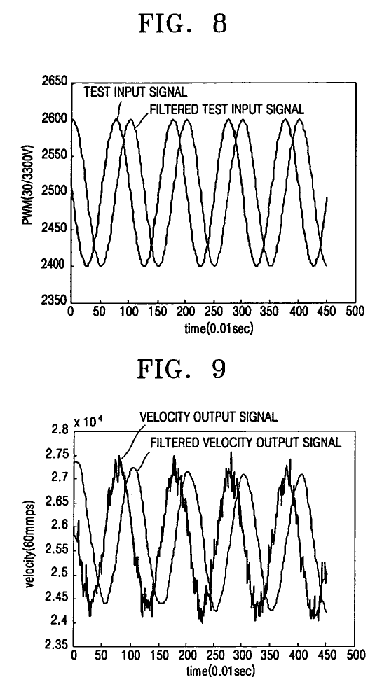

FIG. 8 is a graph illustrating a test input signal and the test input signal filtered by a low pass filter. FIG. 9 is a graph illustrating a velocity output signal and the velocity output signal filtered by the low pass filter. As illustrating in FIG. 9, if the velocity output signal is filtered by the low pass filter, torque ripples of the velocity output signal and the ripples caused by the machine vibrations can be eliminated.

When the velocity output signal is curve-fitted into a linear function to design a filter to eliminate the drift offset, the linear function itself is the drift offset. Thus, the drift offset can be eliminated by offsetting the velocity output signal by a value of the linear function. A detailed algorithm of obtaining the linear function in relation to the drift offset is as follows.
x=[0, T_{S}, 2T_{S}, . . . , (N−1)T_{S}], y=[y(0), y(1), . . . , y(N−1)], [Equation 2
where x denotes time and y denotes a velocity output. N indicates the number of pieces of data measured and Tₛ indicates a sampling interval. First, the average of x and y is calculated as follows.
xₘₑₐₙ=mean(x) [Equation 2]
yₘₑₐₙ=mean(y)

If an inclination of the linear function is A and an intercept corresponding to an initial value of the velocity output y is B, A and B can be calculated using Equation 4.
sumx2=(x-xₘₑₐₙ)(x-xₘₑₐₙ)^{T} [Equation 4]
sumxy=(y-yₘₑₐₙ)(x-xₘₑₐₙ)^{T}
A=sumxy/sumx2
B=yₘₑₐₙ−Axₘₑₐₙ
where T indicates a transpose. The final output of a drift filter is as follows.
y_{f}y−Ax−B [Equation 5]
where y_{f} indicates the final velocity output of the drift filter.

To estimate the system model parameters (K, T), the least square method is applied to the filtered signal.

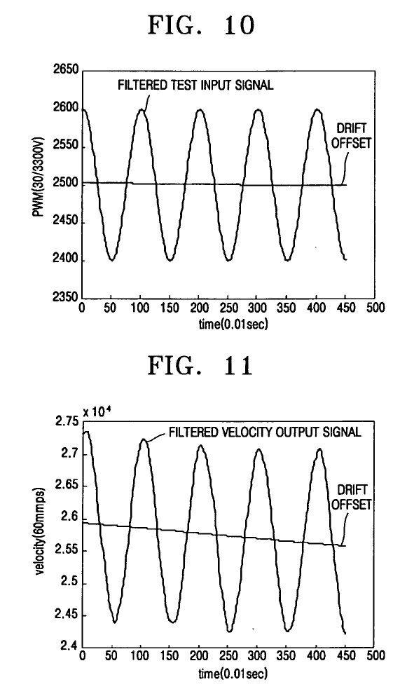

FIG. 10 is a graph illustrating a test input signal filtered by the low pass filter and a drift offset. FIG. 11 is a graph illustrating a velocity output signal filtered by the low pass filter and a drift offset. Referring to FIG. 11, the drift offset of the velocity output signal has a greater inclination than that of the test input signal. As described above, the drift offset of the velocity output signal can be eliminated by obtaining the linear function of the drift offset.

The least square method is based on a discrete time model. Thus, Equation 1 may be converted into a discrete time model as follows.
y(k)=ay(k−1)+bu(k−1)+d(k−1) [Equation 6]

Equation 6 may be converted into a vector format as follows.
y(k)=φ^{T}(k−1)θ+d(k−1) [Equation 7]
where φ((k−1)=[y(k−1)u(k−1)]^{T}
θ=[a b]^{T}.

In Equation 6, since the disturbance (d(k−1)) is eliminated by the pre-filter 20 according to the embodiments present general inventive concept, it is not considered here. If the number of pieces of data is N, Equation 8 can be obtained from Equation 7.
Y=Φθ [Equation 8]
where Y and φ are measurable variables and θ is a parameter to be estimated by the system model inducer 30. Thus, θ is calculated using the least square method as follows.
θ=(Φ^{T}Φ)⁻¹Φ^{T}Y, [Equation 9]
where Φand Y are as follows.

$$Φ = [ \begin{matrix}{ϕ}^{T} ( 0 ) \\ {ϕ}^{T} ( 1 ) \\ ⋮ \\ {ϕ}^{T} ( N - 1 )\end{matrix} ] , Y = [ \begin{matrix}y ( 1 ) \\ y ( 2 ) \\ ⋮ \\ y ( N )\end{matrix} ] . \qquad [ Equation 10 ]$$

As described above, after estimating the parameter θ of the discrete time model using the least square method, if the discrete time model is converted into a successive time model, the system model parameter (K, T) can be estimated by the system model inducer 30.

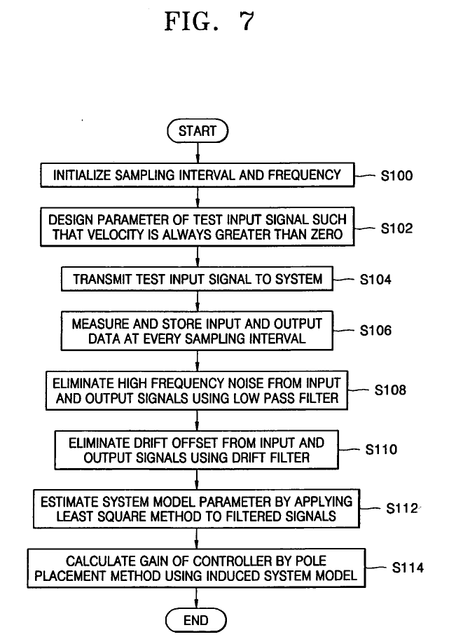

A method of estimating the system model parameter (K, T) and obtaining the gain (Kp, Ki) of the controller will now be described with reference to FIGS. 7 and 15. FIG. 7 is a flowchart illustrating, in more detail, a method of automatically tuning a paper-feeding controller according to an embodiment the present general inventive concept. FIG. 15 illustrates a value of a model parameter and that of a parameter of the paper-feeding controller calculated using the method of FIG. 7.

Referring to FIG. 7, the sampling interval Tₛ and a frequency f of the test signal are initialized (S100). For example, the sampling interval Tₛ can be initialized to 1 msec and the frequency can be initialized to 1 Hz.

Parameters (A, A_{offset}) of the test input signal Vᵢₙ are designed such that an output velocity is always greater than zero (S102). For example, A=100 and A_{offset}=2500. In this case, the test input signal Vᵢₙ is as follows.
Vᵢₙ(k)=A sin(2πfkT_{S})+A_{offset}=100 sin(0.00628k)+2500 [Equation 11]

The test input signal Vᵢₙ is transmitted to the paper-feeding system of the printer (S104). Input and output data of the paper-feeding system is measured at every sampling interval Tₛ by conducting the open loop test, and the measured input and output data is stored (S106). High-frequency noise is eliminated from measured input and output signals using the low pass filter (S108). Adrift offset is eliminated from the measured input and output signals using the drift filter (S108).

The system parameters (K, T) are estimated by applying the least square method to the filtered input and output signals (S112). For example, referring to FIG. 15, the system parameters (K, T) can be estimated at K=14.4 and T=0.0237.

The gain (Kp, Ki) of the PI controller is calculated by the pole placement method using the induced system model (S114). Since the pole placement method to calculate the gain of the PI controller is well-known, a detailed description of the pole placement method is omitted from this disclosure.

In the pole placement method, Equation 12 can be used to calculate the gain of the PI controller.

$${K}_{c} = \frac{2 ζ ω T - 1}{K} , Ti = \frac{2 ζ ω T - 1}{{ω}^{2} T} \qquad [ Equation 12 ]$$

where K_{c} is a gain of the paper-feeding controller.

The gain (Kp, Ki) of the paper-feeding controller can be calculated by Equation 13 using Equation 12.
Kp=K_{c,} Ki=K_{c}/Ti*ControlPeriod [Equation 13]

Referring to FIG. 15, when ω is 100 and ζ(zeta) is 1, Kp=0.3291 and Ki=0.0241. By using the method described above, the paper-feeding system is identified and the gain of the PID controller is calculated. Then, the velocity of the paper-feeding system can be controlled based on the calculated gain of the PID controller.

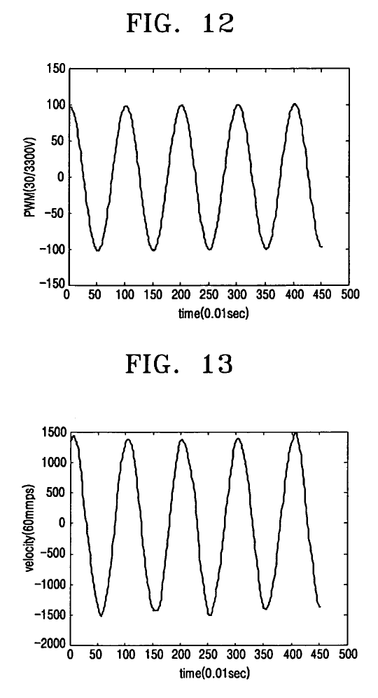

FIG. 12 is a graph illustrating a final output of the pre-filter 20 that filters the test input signal. FIG. 13 is a graph illustrating a final output of the pre-filter that filters the velocity output signal. Referring to FIGS. 12 and 13, it can be seen that a waveform of the test input signal and that of the velocity output signal are similar.

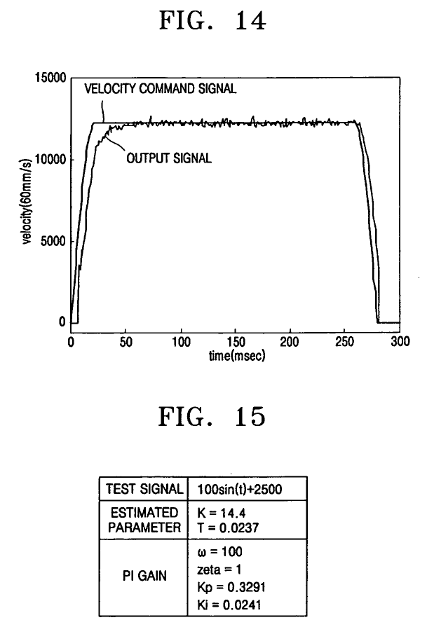

FIG. 14 is a graph illustrating an output signal controlled by the paper-feeding controller based on gain of the paper-feeding controller calculated as described above, according to the embodiments of the present general inventive concept. Referring to FIG. 14, it can be seen that the output signal controlled by the paper-feeding controller is similar to a velocity command signal.

A servo system of a printer can have various types of disturbances, such as load friction, torque ripples, ripples caused by machine vibrations, and drift offsets. However, when a conventional least square method is used, it is difficult to approximate a process model to a process plant due to such disturbances. Accordingly, according to the embodiments of the present general inventive concept, an offset is added to a test input signal so as not to change a plus or minus sign of an output signal such that effects of load friction can be eliminated, a drift offset is eliminated using a drift filter, and noise and a ripple signal of an output signal are filtered using a low pass filter.

The present general inventive concept may be embodied as executable code in computer readable media including storage media, such as magnetic storage media (ROMs, RAMs, floppy disks, magnetic tapes, etc.), optically readable media (CD-ROMs, DVDs, etc.), and carrier waves (transmission over the Internet).

As described above, the embodiments of the present general inventive concept can minimize effects of disturbances present in a paper-feeding system of a printer, acquire a more accurate system model, and ultimately, obtain improved control performance.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of automatically tuning a controller in a paper-feeding system of a printer using a DC motor, the method comprising:
acquiring input and output data of the paper-feeding system by conducting an open loop test;
pre-filtering the input and output data to eliminate a drift offset from the acquired input and output data;
approximating the paper-feeding system using the pre-filtered input and output data to induce a system model; and
calculating a gain of the controller using the induced system model and controlling a velocity of the paper-feeding system according to the calculated gain.

2. The method of claim 1, wherein the acquiring of the input and output data comprises:
inputting a test signal that maintains a plus or minus sign of an output velocity unchanged to eliminate effects of load friction.

3. The method of claim 1, wherein the pre-filtering of the input and output data comprises:
filtering the input and output data to eliminate a drift offset using a predetermined curve fitting method to design a filter.

4. The method of claim 1, wherein the pre-filtering of the input and output data comprises:
eliminating torque ripples and ripples caused by machine vibrations by low pass filtering the input and output data.

5. The method of claim 1, wherein the approximating of the paper-feeding system comprises:
inducing the system model from the pre-filtered input and output data using a least square method.

6. The method of claim 1, wherein the calculating of the gain of the controller comprises:
calculating the gain of the controller by a pole placement method using the induced system model.

7. The method of claim 1, wherein the controller comprises a proportional, integral and derivative controller.

8. A method of automatically tuning a controller in a paper-feeding system of a printer, the method comprising:
inputting a test signal to the paper-feeding system and measuring the input test signal and an output velocity signal;
pre-filtering the measured input test signal and output velocity signal to remove disturbances therefrom;
modeling the paper-feeding system according to the pre-filtered input test signal and output velocity signal; and
calculating a gain of the controller according to the modeled paper-feeding system to control the velocity of the paper-feeding system of the printer.

9. The method of claim 8, wherein the inputting of the test signal comprises:
initializing a sampling interval and a frequency of the test signal; and
determining parameters of the test signal such that the output velocity signal is always greater than zero.

10. The method of claim 9, wherein the measuring of the input test signal and the output velocity signal comprises:
measuring and storing values of the input test signal and the output velocity signal according to the sampling interval.

11. The method of claim 8, wherein the pre-filtering of the measured input test signal and output velocity signal comprises:
filtering high frequency noise from the measured input test signal and output velocity signal using low pass filtering; and
filtering the measured input test signal and output velocity signal to eliminate a drift offset.

12. The method of claim 11, wherein the filtering of the measured input test signal and output velocity signal to eliminate a drift offset comprises:
curve fitting the measured input test signal and output velocity signal into linear functions, respectively; and
offsetting the measured input test signal and output velocity signal by values of he respective linear functions.

13. The method of claim 8, wherein the modeling of the paper-feeding system comprises:
applying a least square method to the pre-filtered input test signal and output velocity signal to estimate system parameters of the paper-feeding system.

14. The method of claim 13, wherein the calculating of the gain of the controller comprises:
applying a pole placement method to the estimated system parameters of the paper-feeding system to calculate the gain of the controller.

15. An apparatus to automatically tune a controller in a paper-feeding system of a printer using a DC motor, the apparatus comprising:
a data acquirer to acquire input and output data of the paper-feeding system by conducting an open loop test;
a pre-filter to eliminate a drift offset from the acquired input and output data;
a system model inducer to approximate the paper-feeding system using the pre-filtered input and output data to induce a system model; and
a gain calculator to calculate a gain of the controller using the induced system model and to control a velocity of the paper-feeding system according to the calculated gain.

16. The apparatus of claim 15, wherein the data acquirer inputs a test signal that maintains a plus or minus sign of an output velocity unchanged to eliminate effects of load friction.

17. The apparatus of claim 15, wherein the pre-filter comprises a drift filter to eliminate a drift offset using a curve filting method.

18. The apparatus of claim 15, wherein the pre-filter comprises a low pass filter to eliminate torque ripples and ripples caused by machine vibrations.

19. The apparatus of claim 15, wherein the system model inducer induces the system model from the acquired input and output data using a least square method.

20. The apparatus of claim 15, wherein the gain calculator calculates the gain of the controller by a pole placement method using the induced system model.

21. The apparatus of claim 15, wherein the controller comprises a proportional, integral and derivative controller.

22. An apparatus to automatically tune a controller in a paper-feeding system of a printer, the apparatus comprising:
an open loop testing unit to input a test signal to the paper-feeding system and to measure the input test signal and an output velocity signal of the paper-feeding unit;
a pre-filtering unit to pre-filter the measured input test signal and output velocity signal to eliminate disturbances therefrom; and
a calculating unit to estimate a model of the paper-feeding system according to the pre-filtered input test signal and output velocity signal and to calculate a gain of the controller according to the estimated model of the paper-feeding system to control a velocity of the paper-feeding system.

23. The apparatus of claim 22, wherein the open loop testing unit measures values of the input test signal and the output velocity signal at a predetermined sampling interval.

24. The apparatus of claim 22, wherein the input test signal comprises test signal parameters determined such that the output velocity signal is always greater than zero.

25. The apparatus of claim 22, wherein the pre-filtering unit comprises:
a low pass filter to eliminate high frequency noise from the measured input test signal and output velocity signal; and
a drift signal to eliminate a drift offset from the measured input test signal and output velocity signal.

26. The apparatus of claim 22, wherein the calculating unit estimates system parameters of the paper-feeding system by applying a least square method to the pre-filtered input test signal and output velocity signal, and calculates the gain of the controller by applying a pole placement method to the estimate system parameters.

27. A paper feeding system usable with a printing apparatus, comprising:
a DC motor to feed paper at a velocity;
a controller to control the velocity of the DC motor; and
a gain calculating unit to conduct and open loop test on the DC motor to obtain input and output values, to pre-filter the input and output values to remove disturbances therefrom, to model a system corresponding to the DC motor according to the pre-filtered input and output values, and to calculate a gain of the controller according to the modeled system.

28. A computer readable storage medium having executable codes to perform a method of automatically tuning a controller in a paper-feeding system of a printer using a DC motor, the method comprising:
acquiring input and output data of the paper-feeding system by conducting an open loop test;
pre-filtering the input and output data to eliminate a drift offset from the acquired input and output data;
approximating the paper-feeding system using the pre-filtered input and output data to induce a system model; and
calculating a gain of the controller using the induced system model and controlling a velocity of the paper-feeding system according to the calculated gain.
